(19) United States
(12) Patent Application Publication
(10) Pub. No.: US 2002/0057996 A1
(43) Pub. Date: May 16, 2002

(54) Centrifuge tube assembly

(76) Inventor: Leland L. Bass, Pomona, CA (US)

Correspondence Address: BONIARD I. BROWN, 1500 West Covina Parkway, #113, West Covina, CA, 91790, US

(21) Appl. No.: 10/040,565

(22) Filed: Jan. 4, 2002

Related U.S. Application Data
(63) Continuation-in-part of application No. 09/545,655, filed on Apr. 10, 2000, now abandoned.

(51) Int. Cl. B01L 3/14

(52) U.S. Cl. 422/102; 422/72; 422/100

(57) ABSTRACT

A tube apparatus for providing a specimen for microscopic examination has a tube with a separator therein to provide, upon centrifuging the tube, an air pocket between the separator and its outlet a space which defines the size of a specimen to be dispensed. A spring and plug may be provided between the separator and a plug and pin thereon to dispense a defined specimen by urging the pin against a specimen holder.

### RELATED APPLICATIONS

This is a continuation-in-part of my co-pending application Ser. No. 09/545,655, filed Apr. 10, 2000,

### BACKGROUND AND SUMMARY OF THE INVENTION

Prior art methods of providing a specimen for microscopic examination have involved substantial time and services of a technician. The procedure includes the provision of a quantity of liquid specimen in a tube, typically 10 ml, sealing the tube and centrifuging, typically at relatively high speed, such as 2500 rpm. The tube is then unsealed and most of the liquid is poured from the tube, leaving a desired specimen of about 1 ml which contains sediment disposed in the lower portion of the tube by the centrifuging. The technician then draws a small sample, as by an eyedropper, and deposits the same on a slide for viewing under a microscope. The procedure is subject to human error and requires substantial time and service of the technician. The present invention provides a tube apparatus which simplifies the procedure of providing a specimen for examination. The tube has therein a separator having its upper portion sealingly engaged in the lower portion of the tube, and having a tapered portion and a reduced lower portion which has therein a passage. Centrifuging forces sediment and liquid through the passage in the separator into a lower portion of the tube. The liquid in the lower portion of the tube cannot rise above the separator passage end portion, and an air pocket is therefore created between the separator and the tube wall. The level of liquid in the lower portion of the tube is at the end of the separator outlet passage, and this level provides a predetermined quantity of specimen, typically 1 ml. Excess specimen is eliminated, and the tube is not unsealed for such purpose. The specimen for examination is provided simply by squeezing a portion of the tube to deposit a quantity, such as a drop, of specimen onto a holder or slide. The sealed tube is then discarded. Removal of a plug in an outlet nozzle portion of the tube results in no substantial leakage because of the partial vacuum in the sealed tube, and light squeezing of a portion of the tube produces a selected quantity, such as a drop, of specimen to the slide or holder.

The time and services of a technician are greatly reduced, and the probability of human error is substantially reduced.

A modified form of the tube assembly of the invention comprises a plug to seal the pipette passage, and a spring between the plug and the separator to urge the plug to close the passage. A pin on the plug extends through and outwardly of the passage, thus to enable the dispensing of a specimen by urging the pin against a specimen holder slide to displace the plug.

In a modified form of the invention, a separator is of generally hemispherical configuration to adapt it to receive a generally hemispherical probe of an apparatus for drawing a specimen from the separator via a passage in the probe for automatic processing.

### BRIEF DESCRIPTION OF THE DRAWINGS

FIG. 1 is an elevational view of a tube apparatus according to the invention showing a separator, pipette and cap thereof;

FIG. 2 is a sectional view of a tube apparatus of FIG. 1 and cap thereof in open position;

FIG. 3 is a perspective view showing the expression of a drop of specimen into a preferred holder device according to a co-pending application of the present inventor;

FIG. 4 is an elevational view of a tube device according to the invention having a frusto-conical separator and a spring member;

FIG. 5 is an enlarged sectional view of the embodiment shown in FIG. 4;

FIG. 6 is a view similar to the lower portion of FIG. 5, and showing a modified spring arrangement;

FIG. 7 is an elevational view of the spring and ball arrangement of the embodiment of FIG. 6;

FIG. 8 is a partial elevational view of a modified separator device utilized with the invention;

FIG. 9 is an elevational view of the tube device of the invention having therein the separator of FIG. 8;

FIG. 10 is an enlarged sectional view of the embodiment of the invention shown in FIG. 9; and

FIG. 11 is an enlarged view of a portion of FIG. 8 encircled by arrow 11, showing a thin edge portion of a separator.

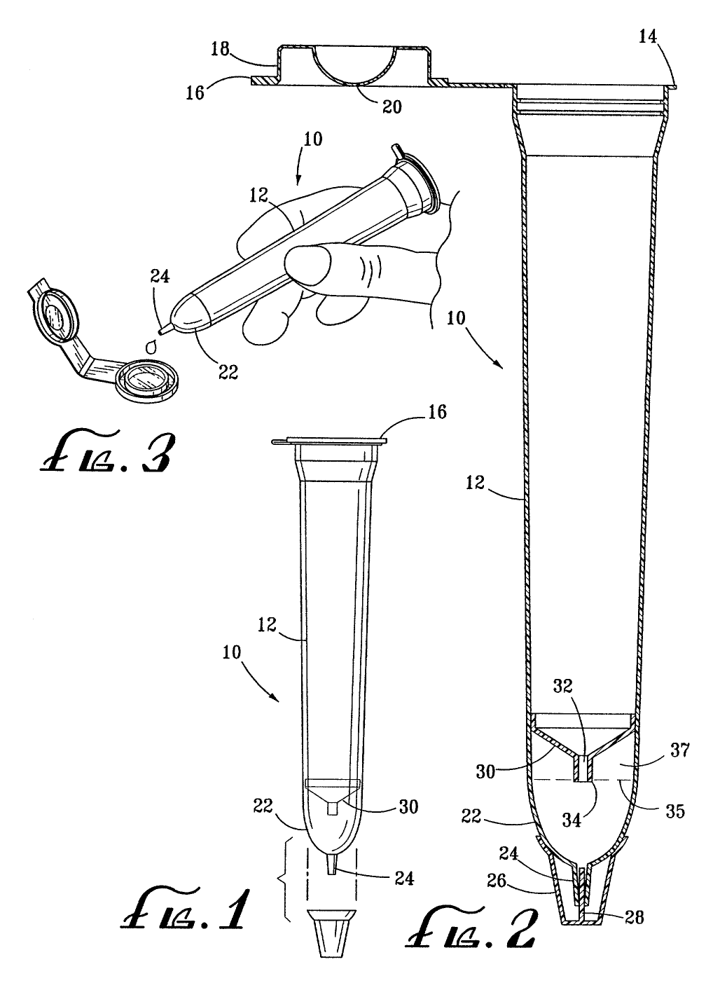

### DESCRIPTION OF THE PREFERRED EMBODIMENTS

Referring to the drawings, a tube 10 is provided for liquid specimens for microscopic analysis, such as urine with particles therein.

The tube comprises an elongated, generally tapered body portion 12 of circular cross-section, and upper outwardly extending thin rim 14, and a hinge strip extending therefrom and at its end a cap 16 connected therewith. The cap has a rim portion, as shown, and a body portion 18 adapted to fit sealingly within the upper opening of the tube. The interior portion of the cap has a domed portion 20. The tube and the cap are preferably fabricated of a flexible, resilient material for resilient sealing of components relative to each other, and to enable squeezing and compression.

The opposite end or bottom portion 22 of the tube is rounded and tapered, and a pipette end portion 24 extends therefrom. An inwardly tapering frusto-conical passage in this end portion is closable by a plug or pin extending axially of a cap 26 which is adapted to seat against the lower end portion of the tube, as shown. A fluid-tight closure is provided by thus engaging the plug 28 in the passage of the pipette portion 24 to provide a closed system for elimination of the chance of contamination.

A funnel-shaped separator 30 is positioned in the lower portion of the tube. It is inserted by being urged downwardly, as by an appropriate instrument through the tapered body 12 of the tube into a position, such as that shown, wherein it is sealingly engaged by force-fit in the inner wall of the tube. Separator 30 has a small passage 32 in a reduced cylindrical end portion 34.

In accordance with the invention, the quantity of liquid with particles therein, to be examined, typically 10 mm of urine or other body fluid, is poured into the tube to a predetermined level within ¼″ to 1½″ the upper end of the tube. The tube is closed and sealed with the cap 16 in sealing engagement with bead he 14 which extends about the upper edge of the tube, as shown, and with the bottom end of the tube sealed by insertion of plug or pin 28 in pipette portion 24.

The tube is then centrifuged, in conventional manner, its lower portion disposed radially outwardly, at typically 2400 rpm for about 5 minutes. Centrifuging causes urine and particles therein (blood cells, particles, skin cells, drug components, etc.) to pass via the separator 30 and the reduced passage 32 therein, into lower portion 22 of the tube. The lower portion of the tube is filled by the centrifuging to a level 35 at the lower end of separator passage 34 (FIG. 2). The level cannot rise higher because of the air pocket defined about the separator within the tube, which cannot be displaced.

Centrifuging forces sediment and particles to the bottom portion of the tube, while the air pocket at 37 is maintained.

The air pocket defines a predetermined specimen quantity, typically 1 ml below the exit passage of separator 30.

With the tube filled with specimen liquid, such as urine with particles therein, to a predetermined level, such as 10 ml, liquid does not pass through separator opening 32 because of its small size, and only a few drops may typically pass therethrough.

Regarding the air pocket, the level of liquid in the tube cannot rise higher than the level indicated at 35, because of the air pocket. The air pocket 37 is maintained even though sediment fills the tube to the bottom of the funnel. Sediment may continue to pass down through passage 32 of the separator.

Centrifuging causes liquid and sediment therein to pass via the separator passage to the level of the lower end of the separator passage, and is prevented from rising above this level by air pocket 37.

In accordance with earlier description, it will be understood that the air pocket is created by the passage of liquid through the passage 24 in the separator, to a level at which it creates the air pocket.

After centrifuging, the air pocket 37 is automatically maintained, and sediment continues to pass via the separator and displaces urine which moves upwardly via the passage 32 of the separator. The heavier sediment first fills the bottom of the tube, displacing urine, and the liquid, being lighter, passes upwardly through the separator passage.

With the invention, specimen sediment is automatically mixed by action of the separator and the air pocket it provides.

With the invention, it is not necessary to pour off liquid from the tube. With the invention, the tube is sealed and is not re-opened and urine is not spattered about upon removing a stopper from a pipette portion.

A technician simply taps or shakes the tube before squeezing a portion of the tube to permit a specimen drop from the pipette passage. Urine and sediment particles are in correct proportions for examination. A technician simply removes the plug from the pipette passage, and squeezes the tube to provide an appropriate specimen. Plug 28 in the pipette passage prevents blockage of the passage by sediment passing therethrough.

Removal of the plug from the pipette passage effects sufficient pressure reduction in the tube for partial vacuum to substantially reduce any leakage via the pipette passage.

Pressure on the tube to expel a specimen, such as a drop, outwardly from the pipette passage, may be effected by manual compression of a portion of the tube or by exertion of pressure on known portion 20 of the cap,

The specimen or drop may be positioned where desired on the slide or holder for microscopic examination. In contrast, in the prior art, it is the customary practice to depend upon capillary action to position or dispose a specimen on a slide.

It is not necessary to pour any excess specimen from the tube, as is done in the prior art, requiring opening of the tube, pouring or siphoning off tube contents to leave only about 1 ml at the tube bottom. Typically the specimen and sediment are then mixed, and an eyedropper or the like is utilized to remove a desired sample, which cannot simply be poured out from the tube, only one drop being required. In contrast, with the present invention, the specimen in the tube is sealed and it is not necessary to unseal it. The closed tube can simply be discarded.

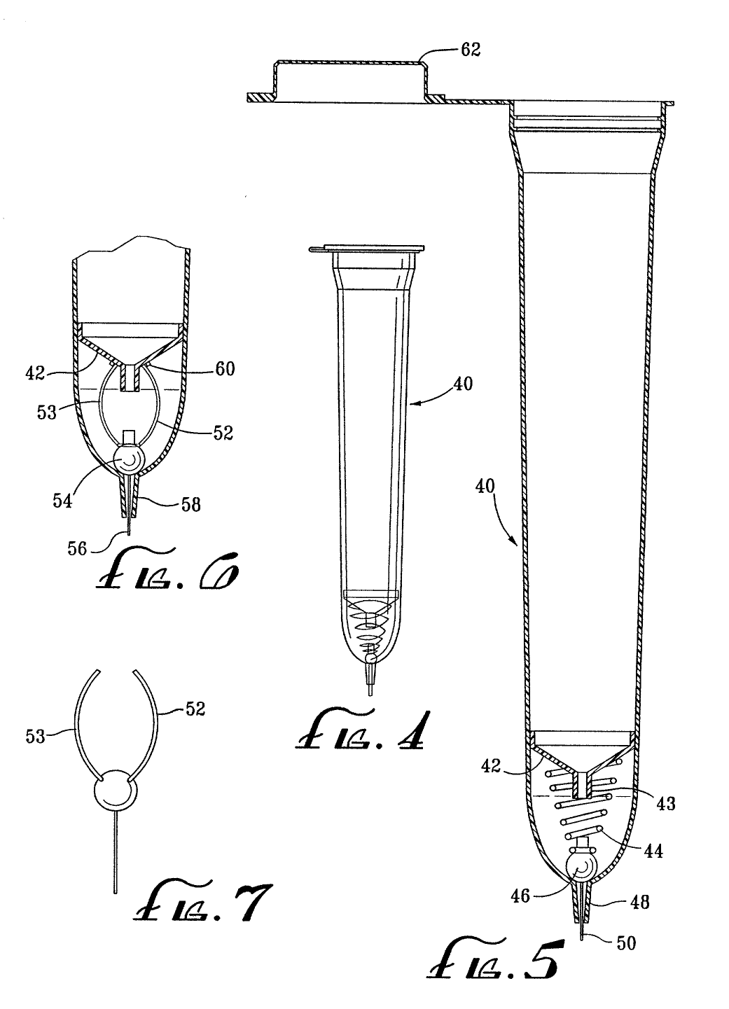

Referring to FIGS. 4-7 there is illustrated a second embodiment of the centrifuge tube apparatus according to the invention. Funnel or separator 42 is similar to separator 30 of the embodiment of FIG. 2. It engages and retains a tapered helical spring 44 which extends into engagement with or securement with a small ball 46, as shown in FIG. 5. Spring 44 is adapted to exert force on the ball to close the passage 46 in pipette portion 48. A pin 50 extends from the ball and through the passage in pipette 48 and outwardly therefrom, as shown. With the pin extending outwardly and urged against an object, the ball is unseated to allow specimen to pass outwardly from the tube.

FIGS. 6 and 7 illustrate a second form of spring 52 which comprises two arcuate elements or bows 52, 53, which are adhered to or are integral with a ball 54 from which a pin 56 extends through a passage in the pipette 58. A ridge 60 may preferably be provided about separator 42 for retention of the spring in position.

A specimen, such as urine, with sediment or particles therein, is dispensed into the tube to such level as to provide a typical sample of 10 cc. No delineating mark is generally necessary to indicate such level. The filled tube is then closed air-tight by cap 62.

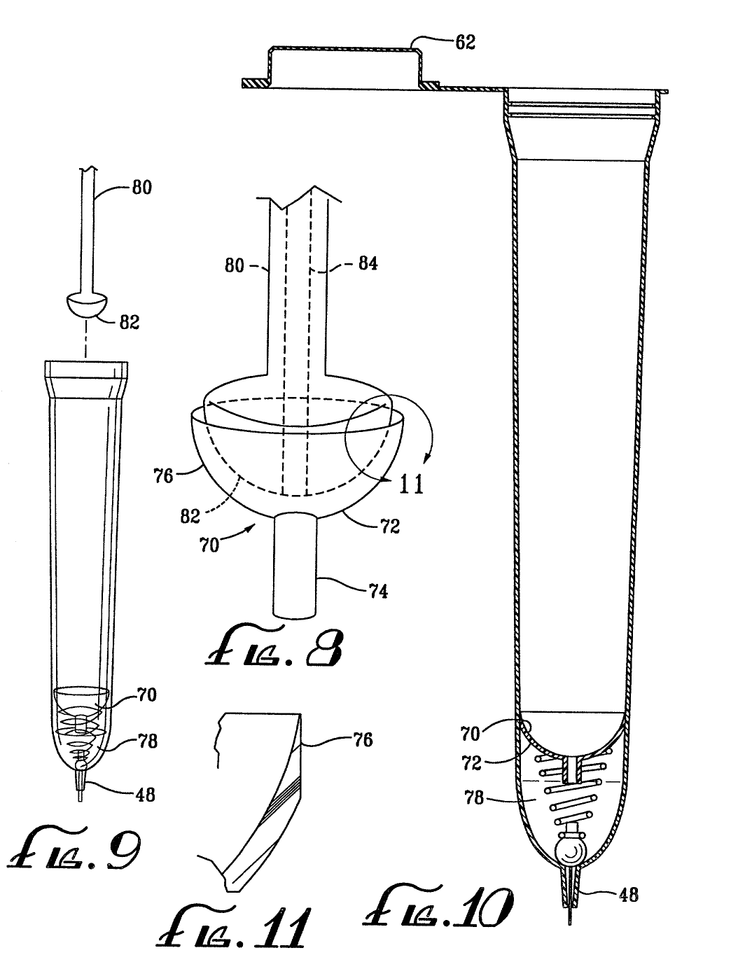

Referring to the drawings, FIGS. 8-11 illustrate an embodiment of the invention adapted for use with a conventional automated “strip” machine. This embodiment is similar in some respects to the embodiment earlier described, and has a pipette portion 48 extending from the end portion of the tube 40 as in the other embodiments. A separator or funnel 70, 72 has a funnel portion of rounded or hemispherical configuration, as shown, rather than the frusto-conical configuration of the other embodiments, and has a reduced lower cylindrical portion. The upper edge portion 76 of the separator portion is tapered to a very small thickness dimension, as shown in FIG. 11 to prevent sediment, etc., of a sample being retained or trapped between the upper edge portion 76 of the separator and the inner wall of the tube. A helical coil spring 78 is like spring 44 of the earlier described embodiment.

An elongated member 80 of a conventional automatic strip machine (not shown) has an enlarged rounded portion adapted to fit into the rounded separator portion, as shown in FIG. 8. A reduced tubular portion 74 extends from the bottom of the rounded portion 76. A specimen is drawn upwardly via a passage 84 in the elongated member 80 for handling by the machine for analysis.

The automatic machine may typically take a specimen as small as 1-2 mm, although the automatic “strip” machine may be Ad adapted to accommodate various specimen sizes. Specimens of about 7.5 ml are typically or preferably utilized with the earlier-described specimens, although this may vary widely.

It will be understood that various changes and modifications may be made from the preferred embodiments discussed above without departing from the scope of the present invention, which is established by the following claims and equivalents thereof.

1. A tube assembly for specimen analysis, comprising:
a tube having a pipette portion extending from a lower end portion thereof, said pipette portion having a passage therethrough, and
a separator having an upper portion sealingly engaged in a lower portion of the tube, said tube having a reduced lower portion defining a passage, whereby upon the filling of the tube to a predetermined level and the centrifuging thereof, centrifuged liquid passes through said separator passage to provide a specimen of predetermined volume defined below the separator and above a lower end of said reduced lower separator portion.

2. A tube assembly according to claim 1, wherein:
said separator has a generally funnel configuration, and an air pocket is defined between the tube, the separator upper portion and an end of the reduced lower separator portion.

3. A tube assembly according to claim 2, wherein a predetermined volume of specimen to be expressed is defined by said air pocket.

4. A tube assembly according to claim 3, wherein the predetermined volume of specimen comprises 0.1 ml.

5. A tube assembly according to claim 1, wherein said separator is sealingly engaged by force-fitting thereof in a tapered portion of the tube.

6. A tube assembly according to claim 1, wherein:
specimen liquid and sediment are automatically mixed during centrifuging by operation of the separator and an air pocket created thereby.

7. A tube assembly according to claim 1, wherein said tube is tapered to narrow toward its lower portion and said separator is force-fitted in a lower portion of the tube.

8. A tube assembly according to claim 1, wherein a bead is disposed about an tipper open end of the tube for sealing engagement with a cap to close the tube.

9. A tube assembly according to claim 1, wherein said tube pipette portion passage is tapered inwardly toward its opening.

10. A tube assembly according to claim 1, and further comprising:
a plug for sealing engagement in said pipette passage,
said plug being disposed in a cup adapted to engage a lower portion of the tube when the plug is inserted in said pipette passage.

11. A tube assembly according to claim 10, wherein:
upon removal of said plug from the pipette passage, a limited lowering of pressure within the tube tends to retain liquid from dropping through the pipette passage.

12. A tube assembly for specimen analysis, comprising:
a tube having a pipette portion extending from a lower end portion thereof, said pipette portion having a passage therethrough,
a plug for sealing engagement in said pipette passage,
a cap for sealingly closing an upper open end portion of the tube, and
a separator having an tipper portion sealingly engaged in the tube, said tube having a reduced lower portion defining a passage, whereby upon the filling of the tube to a predetermined level and the centrifuging thereof, centrifuged liquid passes through said separator passage to provide a specimen of predetermined volume defined below the separator and above a lower end of the reduced lower separator portion for expressing thereof upon removal of said plug.

13. A tube assembly according to claim 12, wherein:
said separator has a generally funnel configuration, and an air pocket is defined between the tube, the separator upper portion and an end of the reduced lower separator portion.

14. A tube assembly according to claim 12, wherein said predetermined volume of specimen comprises 0.1 ml.

15. A tube assembly according to claim 13, wherein:
specimen liquid and sediment are automatically mixed during centrifuging by operation of the separator and an air pocket created thereby.

16. A tube assembly according to claim 12, wherein said tube is tapered to narrow toward its lower portion and said separator is force-fitted in a lower portion of the tube.

17. A tube assembly according to claim 12, wherein a bead is disposed about an upper open end of the tube for sealing engagement with said cap.

18. A tube assembly according to claim 12, wherein said plug is disposed in a cup adapted to engage a lower portion of the tube when the plug is inserted in said pipette passage.

19. A tube assembly according to claim 18, wherein:
upon removal of said plug from the pipette passage, a limited lowering of pressure within the tube tends to retain liquid from dropping through the pipette passage.

20. A tube assembly according to claim 1, and further comprising:
a plug adapted to seat about said pipette passage to seal the passage,
spring disposed between the plug and the separator to urge the plug to close the pipette passage, and
a pin on said plug and extending through and outwardly from the pipette passage,
whereby a specimen is dispensed by urging said pin against a specimen holder to displace the plug against the urging of the spring.

21. A tube assembly according to claim 20, wherein said spring is an helical tapered spring.

22. A tube assembly according to claim 20, wherein said plug is of at least partially spherical configuration.

23. A tube assembly according to claim 20, wherein said pin extends to an upper end of the pipette passage to facilitate passage of specimen through the passage.

24. A tube assembly according to claim 1, wherein:
said separator has a lower portion of reduced diameter defining a passage therethrough, and
said separator is of generally hemispherical configuration to adapt the separator to receive a generally hemispherical probe of an apparatus for the drawing of specimen via a passage through the probe for automatic processing.

25. A tube assembly according to claim 24, wherein:
an upper edge portion of said generally hemispherical separator is tapered to a reduced thin edge portion to engage an inner wall of the tube to prevent specimen sediment from entering between the separator and the tube wall.
